(19) United States
(12) Patent Application Publication
(10) Pub. No.: US 2008/0007568 A1
(43) Pub. Date: Jan. 10, 2008

(54) SYSTEM AND METHOD FOR VISUALIZATION AND INTERACTION WITH SPATIAL OBJECTS

(75) Inventors: Paul B. Chou, Montvale, NJ (US); Jeffrey G. Elliott, Danbury, CT (US); Jennifer Lai, Garrison, NY (US); Danny C. Wong, Allendale, NJ (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/428,967

(22) Filed: Jul. 6, 2006

(51) Int. Cl. G09G 5/00

(52) U.S. Cl. 345/629

(57) ABSTRACT

A computer program product including machine readable instructions stored on machine readable media, the product for assembling and providing a visual interface for a user to interact with spatial information, the product including: a build subsystem for assembling spatial information by converting drawings including the spatial information into scalable vector graphic (SVG) files; the build sub-system further including instructions for merging graphic data of the spatial information and annotating resources represented within the graphic data; and a run-time subsystem for interpreting assembled spatial information and providing the visual interface; wherein the run-time subsystem includes instructions for display and event management control to provide interaction between the user and the spatial information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The field of the invention relates to a system and a method for the interactive visualization of a physical environment such as a building, printed circuit board or machine. It relates generally to graphical interfaces, and more particularly to a computer/user interface for visually interacting with the physical environment as well as other aggregated sources of information.

2. Background of the Related Art

In our daily lives we are called upon to process large amounts of textual information and to create a spatial mapping of that information in our minds in order to better comprehend and remember it. When we have appropriate mental models for the underlying structure, (e.g., the second floor of an office building or the coach compartment of an airplane), we can apply the information against the model to better assess its impact (e.g., conference room 2N-F28, seat assignment 47A). If we don't have an associated visualization, the information remains abstract and less meaningful.

An increasingly mobile workforce underlines the need for competent and intuitive access to aggregated spatial information of associated workplaces. In the current environment, efficient interaction by a worker with an enterprise's physical underpinnings. For example, in the office environment, the worker should have pre-existing knowledge of the location of people and services (e.g. conference rooms, printers, mailroom, fax machines) as well as the layout of the building. The points of access for enterprise services (i.e. the applications) either do not exist, or are very difficult for users to find and use and have no integration with a user's current location. In a corporate environment, mobile workers, new hires and visitors are the most affected. In some cases, these people represent a large percentage of the population. In a non-corporate environment (e.g., domestic settings) people are called upon in their daily lives to translate textual information to a spatial mapping in their heads (e.g., beans are located in aisle six).

Some general purpose systems include visual programming interfaces for users to create a visualization environment from a library of program modules e.g. present bar charts or pie charts. The visual programming interfaces contain graphical tools for a user to interactively assemble the modules into a network of processes so that the user may visualize his data and/or the inputs and outputs to modules. As the data represented by visualization systems is often complex and/or dense, it is usually organized in a hierarchy and arrangement selected by the visualization designer. Other visualization systems have the capabilities to display read data onto the screen and to allow the user to manipulate the visualization of the data by changing associated parameters of the visualization.

Existing visualization of physical environments (e.g., airplane compartments, orchestra seating, or stadium levels) can display a small set of information about the elements (e.g., taken, free, priority seating) and allow users to select one of the elements displayed. However the interaction is limited to simple selection. There is no ability to execute a range of actions on the element, or change the elements in some permanent fashion (e.g., move them around or remove an element completely).

One of the advantages provided by visualization systems is that, due to the significant visual information processing capabilities of the human brain, it is generally easier for an individual to absorb and/or understand data represented visually than data represented in numerical or textual form. A limitation of the prior art is that it does not permit a user to represent a new concept visually.

What is needed is a well designed visualization. Aggregation of data from various sources is preferably integrated into the visualization, providing for an information rich environment.

### SUMMARY OF THE INVENTION

The shortcomings of the prior art are overcome and additional advantages are provided through the provision of a computer program product including machine readable instructions stored on machine readable media, the product for assembling and providing a visual interface for a user to interact with spatial information, the product including: a build subsystem for assembling spatial information by converting drawings including the spatial information into scalable vector graphic (SVG) files; the build sub-system further including instructions for merging graphic data of the spatial information and annotating resources represented within the graphic data; and a run-time subsystem for interpreting assembled spatial information and providing the visual interface; wherein the run-time subsystem includes instructions for display and event management control to provide interaction between the user and the spatial information.

Also disclosed is a computer implemented method for assembling and providing a visual interface for a user to interact with spatial information, the method including: assembling spatial information by converting drawings including the spatial information into scalable vector graphic (SVG) files; merging graphic data of the spatial information; annotating resources represented within the graphic data; and interpreting assembled spatial information to provide the visual interface; wherein the interpreting provides for display and event management control to enable interaction between the user and the spatial information.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution in which a computer program product includes machine readable instructions stored on machine readable media, the product for assembling and providing a visual interface for a user to interact with spatial information comprising at least one of locations; navigations; directories; sensors; appliances; information technology (IT) resources; heating, ventilation and air-conditioning (HVAC), the product including a build subsystem for assembling spatial information by converting drawings including the spatial information into scalable vector graphic (SVG) files; the build sub-system further including instructions for merging graphic data of the spatial information and annotating resources represented within the graphic data; wherein annotating resources includes associating event information with the spatial information; a run-time subsystem for interpreting assembled spatial information and providing the visual interface; wherein the visual interface has at least one of a graphical user interface, an interactive map, a hardware parts list, a components list, a graphical search interface, instructional graphics, graphical indicator signage, a service linkage, an application linkage and an application launching linkage; wherein the run-time subsystem includes instructions for display and event management control to provide interaction between the user and the spatial information and further provides information regarding events associated with the spatial information, the events providing for interaction between the user and the spatial information; and wherein the events include at least one of manipulation of computer network resources; manipulation of resources associated with the spatial environment and monitoring of resources associated with the spatial environment; an interface to external systems for communicating information; a facility for personalization of the visual interface; a facility for role-based functional personalization of the applications; and instructions for customizing spatial image representation based on a context of the visual representation.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an exemplary computing system for implementation of the interface presented herein;

FIG. 2 illustrates one example of components and relationships for an interface as disclosed herein; and

FIG. 3 illustrates one example of the interface that provides for a single access point to services.

The detailed description explains the preferred embodiments of the invention, together with advantages and features, by way of example with reference to the drawings.

### DETAILED DESCRIPTION OF THE INVENTION

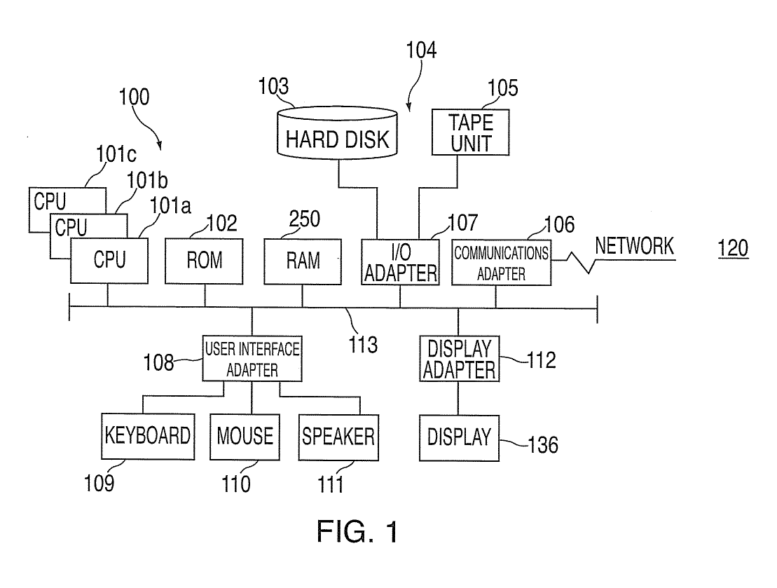

Referring now to FIG. 1, an embodiment of a data processing infrastructure (100) is depicted. System (100) has one or more central processing units (processors) (101a), (101b), (101c), etc. (collectively or generically referred to as processor(s) (101)). Processors (101) are coupled to system memory (250) and various other components via a system bus (113). Read only memory (ROM) (102) is coupled to the system bus (113) and may include a basic input/output system (BIOS), which controls certain basic functions of infrastructure (100).

FIG. 1 further depicts an I/O adapter (107) and a network adapter (106) coupled to the system bus (113). I/O adapter (107) may be a small computer system interface (SCSI) adapter that communicates with a hard disk (103) and/or tape storage drive (105) or any other similar component. I/O adapter (107), hard disk (103), and tape storage device (105) are collectively referred to herein as mass storage (104). A network adapter (106) interconnects bus (113) with an outside network (120) enabling data processing infrastructure (100) to communicate with other such systems. Display monitor (136) is connected to system bus (113) by display adaptor (112), which may include a graphics adapter to improve the performance of graphics intensive applications and a video controller. In one embodiment, adapters (107), (106), and (112) may be connected to one or more I/O busses that are connected to system bus (113) via an intermediate bus bridge (not shown). Suitable I/O buses for connecting peripheral devices such as hard disk controllers, network adapters, and graphics adapters typically include common protocols, such as the Peripheral Components Interface (PCI) bus. Additional input/output devices are shown as connected to system bus (113) via user interface adapter (108) and display adapter (112). For example, a keyboard (109), mouse (110), and speaker (111) all interconnected to bus (113) via user interface adapter (108). Other exemplary and non-limiting user interface devices include a touch screen, a graphic tablet, a microphone, a biometric scanner, an authentication device, an access control, a smart card reader and any one or more of a variety of other devices.

Thus, as configured FIG. 1, the infrastructure (100) includes a variety of resources and a variety of relationships between the resources. Clearly, one skilled in the art will recognize that the infrastructure (100) of FIG. 1 is a vastly simplified sketch of components that may only be a part of the computing infrastructure (100).

The teachings herein provide for the visualization, interaction and examination of aggregated spatial and textual information. The aggregated spatial and textual information is presented in an intuitive graphical interface accessible and usable to the layman as a typical user. The user is provided with a graplical user interface which allows a wide range of interactions with information related to the physical environment.

As used herein, the method and the system make use of a “scalable vector graphic” (SVG) format for graphics. Typical embodiments of SVG files include information for device independent representations of spatial information that is scalable and accurate with relation to an original representation. However, this is merely exemplary and other similar formats may be used (for example, other formats may not rely upon vectors, may be scalable or accurate in limited circumstances, or be similarly characterized).

Events can be assigned to individual graphic components of each SVG file. This enables the user to interact with any graphic or text component of a drawing providing aspects of the information. For example, a user can use the mouse (110) to click on items such as labels, lines, circles, rectangles, embedded icons etc. to initiate a function. This function can then trigger additional processes as desired. Non-limiting examples include actions such as displaying detailed information about the related item, installation of a component (such as a printer for a displayed for a printer icon) and generation of a status report describing aspects of the related item.

Typically, a set of tools for integrating the spatial representation with the events required for the interaction is provided. For example, in one embodiment, an off-line utility processes the SVG graphic file (in one case, the SVG graphic file is provided as XMLdata) and inserts unique identification information for all or a selection of the graphic elements within the SVG graphic file. This typically calls for parsing the SVG graphic file (XML data) with a suitable XML parser and identifying nodes of interest. Each targeted node is then appended with a unique identifier (ID). Event function calls may also be inserted for each of these nodes or groups of nodes. These function calls link the particular node to a secondary process or operation that is to be performed.

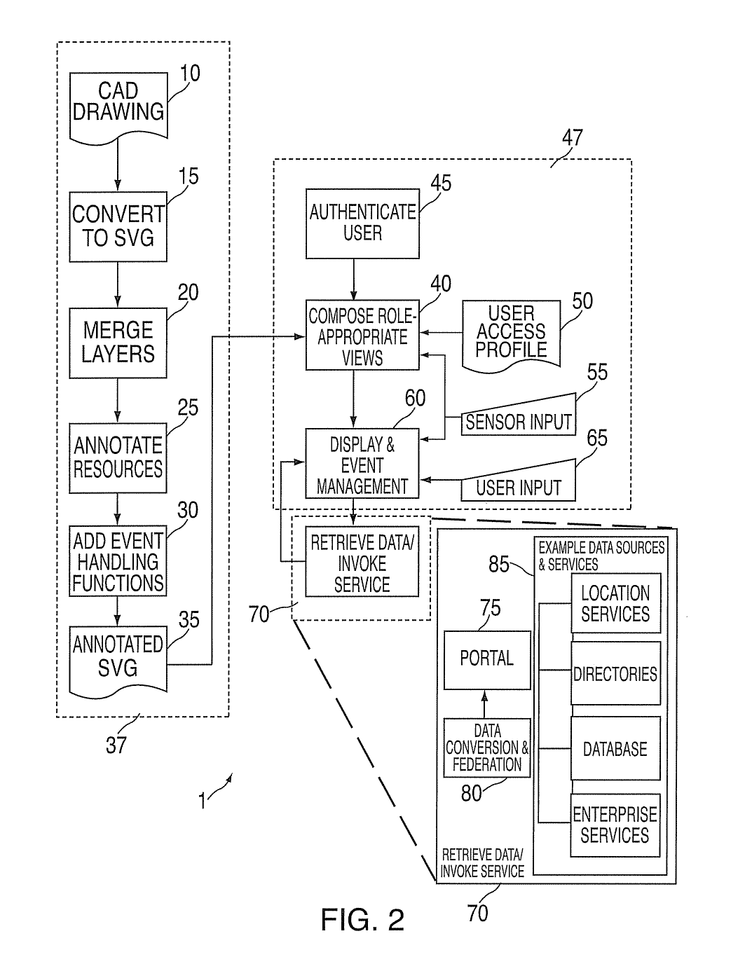

Reference may be had to FIG. 2, which depicts aspects of a typical process providing for visualization and interaction with spatial information. One skilled in the art will recognize that a variety of interactive tools and interfaces for the visualization, aggregation and navigation of information may be had. These tools and interfaces disclosed herein are part of the system (1) and an architecture for the visualization and interaction with the spatial information.

A first portion of the system (1) includes a build subsystem (37) for assembling spatial information. In this regard, the system (1) provides for the conversion to SVG (15) of CAD drawings (10). Typically, the spatial information is contained within the CAD drawings (10). Exemplary spatial information includes information regarding facilities, parts, layouts and other such information. Conversion to SVG (15) is typically performed using common graphic tools such as Adobe Illustrator or InkScape. Typically, conversion to SVG (15) provides for data in the scalable vector graphic (SVG) format, however, other formats may be deemed suitable. If a graphic is already in SVG format, the graphic can also be used directly without the conversion process.

Typically, the system (1) then provides for modifications to the converted scalable vector graphic to simplify, standardize, merge and separate the graphic data into layers. In one embodiment, one layer contains geometric data, while other layers include identifying labels. Although a variety of tasks and techniques may be accomplished in this step, this is generally referred to (and for simplicity only) as “merging layers (20).” Once merging layers (20) is completed, the system (1) provides annotated resources.

Annotating resources (25) assigns a unique identification tag to each graphic element and identifies the element (e.g., a conference room). Optionally, the system (1) may add event handling functions (30). In the step where the system (1) adds event handling functions (30), the system (1) associates an event method or methods to some or all of the elements, thus providing a mechanism for user interaction. Non-limiting examples include providing for actions such as displaying detailed information about the item clicked, starting an installation for a component (such as printer installation for a displayed printer icon) and generation of a status report (such as for providing a status regarding a component of the resource). Once assembled, the annotated SVG graphic (35) is then used for the spatial visual interface for the user.

The system (1) makes use of the spatial information once the information is assembled with the various additions and compliments deemed suitable. When the assembled spatial information is available, the system (1) operates a run-time subsystem (47). The run-time subsystem (47) may include a variety of features for enhancing the visualization experience. Exemplary aspects of the run-time subsystem (47) include authentication (45), profile management (50) and display and event management control (60).

In an exemplary embodiment, after the user is authenticated by any convenient method, the user's access profile is drawn on to obtain information such as a default format for the session interface. Those skilled in the art will be familiar with stored preferences specific to the particular user. The user will be provided access to various input devices as are known in the art and a part of the infrastructure (100).

Sensor information (55) is used to dynamically compose a spatial graphical user interface (40) based on various building blocks by selecting those blocks that seem appropriate for the particular situation. The blocks enable specified data, such as present location or user role, to alter the data content and the visual presentation based on such specified data. Exemplary sensor information (55) includes input from user devices such as the mouse (110), graphics tablet, touch screen and other similar devices.

Composing a spatial graphical user interface (40) is typically considered to be part of the run-time subsystem (47). One reason is that composing typically operates using a default interface after the user has delivered some input.

The system (1) provides a single point, spatial visual interface for user interaction with the run-time subsystem (47) using a diverse collection of spatial information, user input devices and services. Rather the sending the user to multiple pages or locations, the user is provided with and makes use of a single view to interact with the spatial information environment. This results in significant time savings for the user.

Typically, the run-time subsystem (47) centers on display and event management control (60), which controls the display and handles the various associated events.

Composing the spatial graphical user interface (40) is performed in conceit with display and event management (60) (that is, the interface works with an event manager) to change a user display in response to events. The events, as discussed above may include user input (65) and result in changing at least an aspects of the view provided in the interface, either automatically or as a result of display and event management control (60).

The event manager of the display and event management control (60) includes a sub-system for both sending and receiving events (which generally describes a signal or request from the user and also signals from the system (1) indicating that some result has been reached). For example, display and event management control (60) provides for display of the result of a calculation requested by the user. In some embodiments, events are used to create specific data requests via a data manager, while some other events are used by a visualization manager for creating a dynamic visual representation of an interaction. One skilled in the art will understand that display and event management control (60) maintains state information, performs data updates for the required services, and manages support for all connected services.

Exemplary events include: manipulation of computer network resources (such as installation of a printer); manipulation of resources associated with the spatial environment (such remotely locking and unlocking of doors); monitoring of resources associated with the spatial environment (such as monitoring ambient room temperature) and others.

In operation, the user will indicate the result desired. One example of an input for the desired result is by checking a box on the display (136) using the mouse (110) as a pointing device.

The invention provides methods for data aggregation and integration (70). Referring to the exploded view of data aggregation and integration (70) in FIG. 2, an exemplary architecture for the system (1) provides single point access to integrated enterprise services and information. The services and information may originate from any one or more of data sources in a distributed, scalable, and extendible environment.

As used herein, the term “single point” with regards to information access makes reference to a desired property of the system (1). That is, the system (1) provides single point access to the user for the various services and information available through the system (1). This is not to say that the system (1) is reliant upon a single device, such as the display (136). Rather, the system (1) provides a variety of tools for the user to have an integrated source of the spatial information.

In typical embodiments, the system (1) is implemented in an interconnected network. In these embodiments, the system (1) includes distributed enterprise services that can communicate with the single access point via the network (120). In addition to networked enterprise services, this architecture design would also work well with local data sources and data base to provide services without network connection.

This design for the system (1) provides for deployment using a traditional HTTP server, a portal server or another type of server having similar capabilities. Typically, the interactive interface provided to the user can be conveniently viewed through a web browser.

The data sources (85) provide a variety of data types. Heterogeneous services to the system (1) provide data that provide for computing and transforming data to spatial information for the interactive visual interface. Exemplary data includes, without limitation, CAD drawings for physical maps, LDAP directories (such as for employee information), device drivers (such as for printers), real-time data (such for a present room occupancy indication), as well as XML and text data for location awareness. The system (1) maintains state information and up-to-date data for the required services as well as providing for management of those data to support all connected services.

Data conversion and federation (80) provides bi-directional translation of data from the various data sources (85). This provides for unified data queries that the portal can retrieve, and converts back to original format when the portal needs to store the data in the data sources (85). Data conversion and federation (80) may be performed entirely on the server, partially on the server, locally to the infrastructure (100) or in some combination thereof.

A portal server (75) plays several roles. For example, the server (75) retrieves and stores information from and to different data sources (85) and data bases. The server (75) also serves as a delivery mechanism for interactive information via portal supporting role-based web access. The server (75) provides basic user management and authentication to permit access to this server.

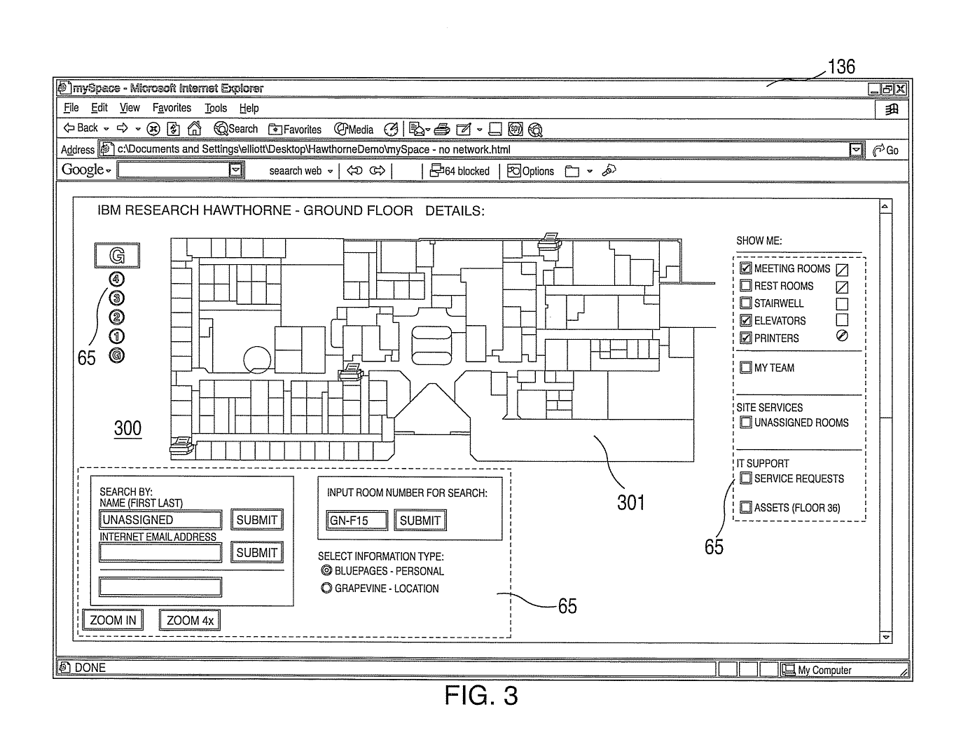

FIG. 3 depicts an interface (300) providing spatial information (301). In this example, the interface (300) includes information (301) regarding a large building having several floors. The center of the display (136) shows a floor plan, wherein various boxes and other shapes indicate rooms on the first layer of the drawing. Other data are presented or made accessible by text or keys on the screen that are on the second (or another) layer of the drawing. Various facilities are available within the interface (300) for accepting the user input (65).

For example, in the upper left corner of the display (136), a floor number display indicates the presently displayed floor. The floor number display also provides for accepting the user input (65). In the lower left corner of the display (136), there is access to a personnel directory for the building. In a right corner of the display (136), there is a list of keys that will display fixed facilities for the building. These include, only as examples, the team to which the user belongs; other departments; site services; IT support; and related information. Typically, the system (1) is established to permit users to add to this list.

In a typical session, a visitor (such as from within the same company, but from a different location) comes to meet with colleagues working on the same project. This is the visitor's first trip to this location. The visitor is provided with a link to a view of the new location (building layout). The visitor and logs in to the page. From this view, the users meeting room is automatically identified (graphic switched to appropriate view and room highlighted) based on the log information and time. The visitor clicks on the graphical representation of the room and is presented with a pop-up window with details about the room (such as, phone number, presentation equipment list, directions, booking information such as meeting participants and times). The visitor then follows the directions to the meeting room. During the meeting the visitor would like to print their presentation as a handout for the other participants. Again, using the same link and view, the user can find the closest printer to the meeting room and by clicking on the printer icon is able to install the appropriate printer driver. In some embodiments, the user is provided a facility for attaching the presentation. In these embodiments, the participants can later access the page and by submitting various requests (typically in the form of filter information, such as presenter, date and time) obtain a copy of the presentation.

The system (1) provides a variety of options for fitting the needs of the user. For example, one user might see additional views or totally different views of the same building than another user. For example, an information technology (IT) technician may be provided with computer network information when they click on a conference room, such as equipment IP address, port labels, and maintenance report/request for the room. A heating, ventilation and air-conditioning (HVAC) maintenance representative might have data that shows the HVAC systems. The HVAC systems could have clickable labels or gauges that would provide feedback to real time information such as room temperature or air-conditioning pressures etc. The same maintenance representative could also click on the air-conditioning compressor and get a parts list and even place the order for a part. In this embodiment, the system (1) includes an interface to external systems for communicating relevant information.

Although referred to herein as a “system (1)” it should be recognized that the teachings herein provide for computer implemented methods equally as well. Therefore, the term “system” is not limiting of the teachings herein, and may include, as appropriate, various combinations of computer implemented instructions, hardware, firmware and other components. As one example, the system for spatial visualization and other associated aspects may be implemented in software using various hardware components. Accordingly, a system for implementation of spatial visualization and interaction will typically include machine readable instructions stored on machine readable media, such as the hard disk 103.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product comprising machine readable instructions stored on machine readable media, the product for assembling and providing a visual interface for a user to interact with spatial information, the product comprising:
a build subsystem for assembling spatial information by converting drawings comprising the spatial information into scalable vector graphic (SVG) files; the build sub-system further comprising instructions for merging graphic data of the spatial information and annotating resources represented within the graphic data; and
a run-time subsystem for interpreting assembled spatial information and providing the visual interface; wherein the run-time subsystem comprises instructions for display and event management control to provide interaction between the user and the spatial information.

2. The computer program product as in claim 1, wherein the spatial information comprises information in regard to at least one of: locations; navigations; directories; sensors; appliances; information technology (IT) resources; heating, ventilation and air-conditioning (HVAC).

3. The computer program product as in claim 1, wherein the run-time subsystem further provides information regarding events associated with the spatial information.

4. The computer program product as in claim 3, wherein the run-time subsystem further provides for interaction between the user and the events.

5. The computer program product as in claim 3, wherein the events comprise at least one of manipulation of computer network resources; manipulation of resources associated with the spatial environment and monitoring of resources associated with the spatial environment.

6. The computer program product as in claim 1 comprising an interface to external systems for communicating information.

7. The computer program product as in claim 1, wherein the visual interface comprises at least one of a graphical user interface, an interactive map, a hardware parts list, a components list, a graphical search interface, instructional graphics, graphical indicator signage, a service linkage, an application linkage and an application launching linkage.

8. The computer program product as in claim 1, comprising a facility for personalization of the visual interface.

9. The computer program product as in claim 1, comprising a facility for role-based functional personalization of the applications.

10. The computer program product as in claim 1, wherein annotating resources comprises associating event information with the spatial information.

11. The computer program product as in claim 1, further comprising instructions for customizing spatial image representation based on a context of the visual representation.

12. A computer implemented method for assembling and providing a visual interface for a user to interact with spatial information, the method comprising:
assembling spatial information by converting drawings comprising the spatial information into scalable vector graphic (SVG) files;
merging graphic data of the spatial information;
annotating resources represented within the graphic data; and
interpreting assembled spatial information to provide the visual interface; wherein the interpreting provides for display and event management control to enable interaction between the user and the spatial information.

13. A computer program product comprising machine readable instructions stored on machine readable media, the product for assembling and providing a visual interface for a user to interact with spatial information comprising at least one of locations; navigations; directories; sensors; appliances; information technology (IT) resources; heating, ventilation and air-conditioning (HVAC), the product comprising:
a build subsystem for assembling spatial information by converting drawings comprising the spatial information into scalable vector graphic (SVG) files; the build sub-system further comprising instructions for merging graphic data of the spatial information and annotating resources represented within the graphic data; wherein annotating resources comprises associating event information with the spatial information;
a run-time subsystem for interpreting assembled spatial information and providing the visual interface; wherein the visual interface comprises at least one of a graphical user interface, an interactive map, a hardware parts list, a components list, a graphical search interface, instructional graphics, graphical indicator signage, a service linkage, an application linkage and an application launching linkage; wherein the run-time subsystem comprises instructions for display and event management control to provide interaction between the user and the spatial information and further provides information regarding events associated with the spatial information, the events providing for interaction between the user and the spatial information; and wherein the events comprise at least one of manipulation of computer network resources; manipulation of resources associated with the spatial environment and monitoring of resources associated with the spatial environment;
an interface to external systems for communicating information;
a facility for personalization of the visual interface;
a facility for role-based functional personalization of the applications; and
instructions for customizing spatial image representation based on a context of the visual representation.
